(19) United States
(12) Patent Application Publication
(10) Pub. No.: US 2011/0121687 A1
(43) Pub. Date: May 26, 2011

(54) ULTRASOUND PROBE

(75) Inventor: Minoru AOKI, Nasushiobara-shi (JP)

(73) Assignees: KABUSHIKI KAISHA TOSHIBA, TOKYO (JP); TOSHIBA MEDICAL SYSTEMS CORPORATION, OTAWARA-SHI (JP)

(21) Appl. No.: 12/940,261

(22) Filed: Nov. 5, 2010

(30) Foreign Application Priority Data
Nov. 24, 2009 (JP) 2009-266822

(51) Int. Cl. B06B 1/06

(52) U.S. Cl. 310/334

(57) ABSTRACT

A flexible printed circuit board, interposed between an intermediate member and a backing material, covers an almost whole back face of the intermediate member and has first and second wiring patterns. A first electrode is interposed between the piezoelectric transducer and the intermediate member, extracted onto the side face of the intermediate member contiguous with one side face of the piezoelectric transducer, and electrically connected to the first wiring pattern. A second electrode is formed on the ultrasound transmission face of the piezoelectric transducer, extracted by being routed on the other side face of the piezoelectric transducer and a side face of the intermediate member contiguous with the other side face of the piezoelectric transducer, and electrically connected to the second wiring pattern.

### CROSS-REFERENCE TO RELATED APPLICATION

This application is based upon and claims the benefit of priority from Japanese Patent Application No. 2009-266822, filed Nov. 24, 2009; the entire contents of which are incorporated herein by reference.

### FIELD

Embodiments described herein relate generally to an ultrasound probe connected to an ultrasound diagnosis apparatus and configured to transmit and receive ultrasound to and from a subject, more specifically, relate to an electrode structure of a piezoelectric transducer.

### BACKGROUND

There is an ultrasound diagnosis apparatus configured to scan the inside of a subject with ultrasound and image the internal condition of the subject based on a reception signal generated from the wave reflected on the inside of the subject. This type of ultrasound diagnosis apparatus transmits ultrasound into a subject from an ultrasound probe and receives, by the ultrasound probe, a reflected wave caused by a mismatch of acoustic impedance within the subject, thereby generating a reception signal.

An ultrasound probe is provided with a plurality of piezoelectric transducers each of which generates ultrasound by oscillating based on a transmission signal and generates a reception signal by receiving a reflected wave.

FIG. 8 is a cross-section view showing a principal configuration of a conventional ultrasound probe. The principal configuration of the ultrasound probe includes a piezoelectric transducer 11 that generates ultrasound, and acoustic matching layers 41 and 42 that reduce a mismatch of acoustic impedance between the piezoelectric transducer and a living body and an acoustic lens 50 that focuses ultrasound are joined to the piezoelectric transducer 11 toward a living-body contacting face (on an ultrasound transmission face). Moreover, a flexible printed circuit board 20A provided with a wiring pattern that transmits and receives electric signals to and from the piezoelectric transducer 11 and a backing material 30 that attenuates and absorbs extra ultrasound oscillation components are joined to the piezoelectric transducer 11 toward a cable (on the opposite side to the ultrasound transmission face). Through the acoustic matching layers 41 and 42 (from between the acoustic matching layers 41 and 42), a flexible printed circuit board 60 is extracted.

The flexible printed circuit board 20A is provided with a wiring pattern 21A, and the flexible printed circuit board 60 is provided with a wiring pattern 61. Voltage is applied between the wiring pattern 21A and the wiring pattern 61.

Further, as described in Japanese Unexamined Patent Application Publication No. S53-025390, an ultrasound probe having an intermediate layer is known (a member composing the intermediate layer may be referred to as an “intermediate member”). Although the thickness of the piezoelectric transducer needs to be almost a half of the wavelength of ultrasound in a conventional type without the intermediate layer, it is known that the thickness of the piezoelectric transducer can be almost a quarter of the wavelength of ultrasound, which is half of the conventional type, in a case that the intermediate layer is formed. FIG. 9 is a cross-section view showing an example of the ultrasound probe provided with the intermediate layer. As shown in FIG. 9, an intermediate layer 14 is formed on a face of the piezoelectric transducer 11 on the side of the cable (the opposite side to the ultrasound transmission face).

It is known that the acoustic impedance of the intermediate layer is higher than that of the piezoelectric transducer and the thickness of the intermediate layer is almost a quarter (or odd-number multiple thereof) of the wavelength of ultrasound to be used. Gold, lead, tungsten, mercury, sapphire and so on are used as the material of the intermediate layer.

Since there is a need to apply voltage to the piezoelectric transducer between the face on the side of the cable (the opposite side to the ultrasound transmission face) and the ultrasound transmission face, a ground electrode and a signal electrode are formed on the respective faces. A flexible printed circuit board provided with wiring patterns connected to an electric circuit for transmission and reception of electric signals to and from an ultrasound diagnosis apparatus is used. Transmission and reception of signals is performed by connecting the electrodes of the piezoelectric transducer with the wiring patterns of the flexible printed circuit board.

In the structure having the intermediate layer, the back side of the intermediate layer (the opposite side to a face joined to the piezoelectric transducer) is joined to the flexible printed circuit board, and transmission and reception of signals of ultrasound is thereby allowed. For joining the piezoelectric transducer to the intermediate layer and joining the intermediate layer to the flexible printed circuit board, an epoxy adhesive or the like is generally used.

In order to drive the piezoelectric transducer, it is necessary to apply voltage to between the signal electrode and the ground electrode described above. For example, as shown in FIG. 9, the electrode of the piezoelectric transducer can be extracted through the matching layers.

In FIG. 9, transmission and reception of signals is performed between the wiring patterns 21A and 61 respectively formed on the flexible printed circuit boards 20A and 60. The flexible printed circuit board 20A is interposed between the intermediate layer 14 and the backing material 30, and is provided with the signal electrode (not shown) on a face joined to the intermediate layer 14. Moreover, the flexible printed circuit board 60 is joined to the piezoelectric transducer 11 via the second acoustic matching layer 42, and is provided with the ground electrode (not shown) on a face joined to the second acoustic matching layer 42.

According to the above structure, in order to extract a signal onto the ultrasound transmission face, there is a need to install the flexible printed circuit board 60. Since a conductive wire joined to the ground electrode to extract a signal, a resin layer for fixing the conductive wire, and so on are laminated on the flexible printed circuit board, the flexible printed circuit board is thicker than an electrode alone. Moreover, since a metal layer having large acoustic impedance is contained, there is a problem that the acoustic matching condition is disturbed and the acoustic property deteriorates.

As another conventional technique, which solves the above problem, a method of routing the electrode on the ultrasound transmission face of the piezoelectric transducer toward the back face of the piezoelectric transducer via a side face of the piezoelectric transducer is proposed as described in Japanese Unexamined Patent Application Publication No. 2007-167445. FIG. 10 is a cross-section view showing an example of an ultrasound probe described in JP-A 2007-167445. As shown in FIG. 10, the ground electrode 16 and the signal electrode 12 are each electrically joined to the flexible printed circuit board 20 on the opposite face to the ultrasound transmission face of the piezoelectric transducer 11. Consequently, the need for mounting a flexible printed circuit board for extracting a signal on the side of the ultrasound transmission face of the piezoelectric transducer 11 is eliminated, and it becomes possible to prevent the acoustic property from deteriorating.

Meanwhile, since the ultrasound probe described in JP-A 2007-167445 does not have the intermediate layer, there is a need to make the thickness of the piezoelectric transducer almost a half of the wavelength of ultrasound as in a conventional type.

A method for solving both the problems can be considered by applying the technique of routing the electrode formed on the ultrasound transmission face of the piezoelectric transducer to the back face of the piezoelectric transducer via the side face of the piezoelectric transducer as described in JP-A 2007-167445, to the ultrasound probe having the intermediate layer on the back face of the piezoelectric transducer described in JP-A S53-025390 as mentioned above. In this case, specifically, a configuration of applying a laminate of the piezoelectric transducer 11 and the intermediate layer 14 of FIG. 9 to a part corresponding to the piezoelectric transducer 11 of FIG. 10 can be considered.

However, in this case, the intermediate layer having conductivity is joined immediately under the piezoelectric transducer, and therefore, it is difficult to separately connect the signal electrode and the ground electrode to the flexible printed circuit board. This is problematic because voltage is not applied when a nonconductive material is used as the intermediate layer, whereas the signal electrode and the ground electrode cause short circuit when a conductive material is used as the intermediate layer. Therefore, in a case that the structure having the intermediate layer is used, as shown in FIG. 9, the method of extracting the electrode of the piezoelectric transducer through the matching layers must be employed.

Further, in the case of realizing the method described in JP-A 2007-167445, there is a need to form the ground electrode and the signal electrode on a face to which the flexible printed circuit board is joined.

Therefore, there is another problem that an effective driving area of the piezoelectric transducer is small, which makes the size of the ultrasound probe large and leads to decrease of operability.

### BRIEF DESCRIPTION OF THE DRAWINGS

FIG. 1 is a cross-section view of an ultrasound probe according to an embodiment.

FIG. 2 is a cross-section view of a piezoelectric oscillation component in the embodiment.

FIG. 3 is an exploded view of the piezoelectric oscillation component, a backing member and a flexible printed circuit board in the embodiment.

FIG. 4A is an explanation view of a method for generating the piezoelectric oscillation component in the embodiment.

FIG. 4B is an explanation view of the method for generating the piezoelectric oscillation component in the embodiment.

FIG. 4C is an explanation view of the method for generating the piezoelectric oscillation component in the embodiment.

FIG. 4D is an explanation view of the method for generating the piezoelectric oscillation component in the embodiment.

FIG. 5A is an explanation view of a method for generating a piezoelectric oscillation component in a modified example 1.

FIG. 5B is an explanation view of the method for generating the piezoelectric oscillation component in the modified example 1.

FIG. 6A is an explanation view of a method for generating a piezoelectric oscillation component in a modified example 2.

FIG. 6B is an explanation view of the method for generating the piezoelectric oscillation component in the modified example 2.

FIG. 6C is an explanation view of the method for generating the piezoelectric oscillation component in the modified example 2.

FIG. 7 is a magnified cross-section view of FIG. 6B.

FIG. 8 is a cross-section view for explaining a configuration of a conventional ultrasound probe.

FIG. 9 is a cross-section view of a conventional ultrasound probe having an intermediate layer.

FIG. 10 is a cross-section view of a conventional ultrasound probe in which both a signal electrode and a ground electrode are connected to a flexible printed circuit board on the back face of a piezoelectric transducer.

### DETAILED DESCRIPTION

An object of an embodiment described herein is to provide an ultrasound probe that is structured to have an intermediate layer on the back face of the piezoelectric transducer and configured to prevent deterioration of the acoustic property by omitting a flexible printed circuit board formed on the ultrasound transmission face.

Another object of this embodiment is to provide an ultrasound probe configured to have a large effective driving area of the piezoelectric transducer so that its size can be small.

This embodiment provides an ultrasound probe configured by superposing a piezoelectric transducer, an intermediate member and a backing member in this order on the rear side of the ultrasound transmission face of the piezoelectric transducer, the ultrasound probe being provided with a flexible printed circuit board, a first electrode and a second electrode. The flexible printed circuit board is interposed between the intermediate member and the backing material, configured to cover an almost whole back face of the intermediate member, and provided with a first wiring pattern and a second wiring pattern. A first electrode is interposed between the piezoelectric transducer and the intermediate member, extracted through the side face of the intermediate member contiguous with one side face of the piezoelectric transducer, and electrically connected to the first wiring pattern. A second electrode is formed on the ultrasound transmission face of the piezoelectric transducer, extracted through the other side face of the piezoelectric transducer and the side face of the intermediate member contiguous with the other side face, and electrically connected to the second wiring pattern.

### Embodiment

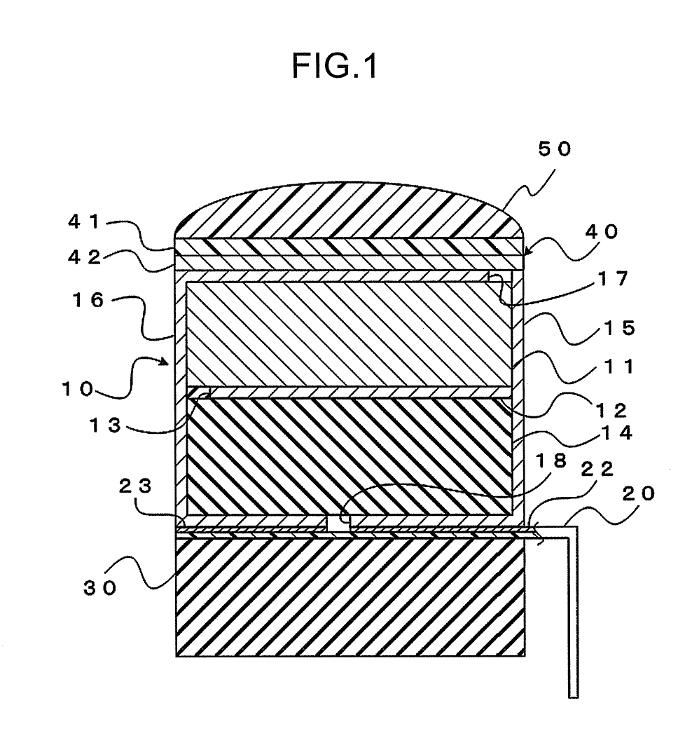

Below, with reference to FIGS. 1 to 3, an ultrasound probe according to an embodiment will be described.

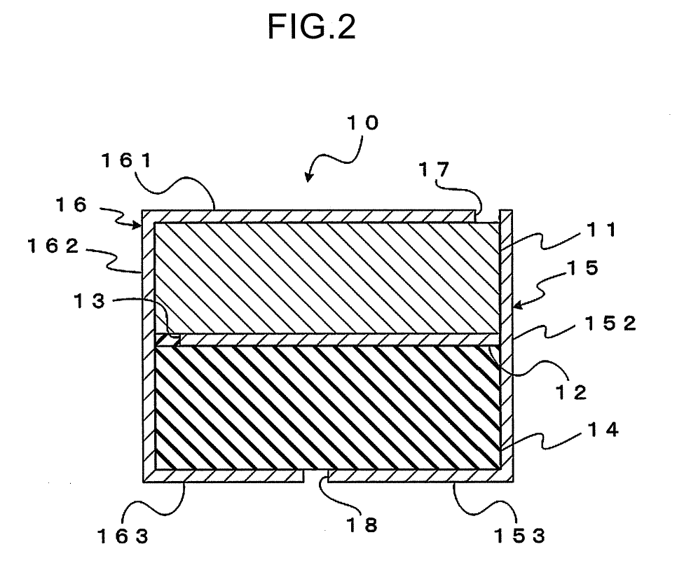

As shown in FIG. 1, the ultrasound probe according to this embodiment is provided with a piezoelectric transducer 11, an intermediate layer 14, and a backing material 30 so as to be superposed in this order. On the ultrasound transmission face of the piezoelectric transducer 11, an acoustic matching layer 40 and an acoustic lens 50 are superposed in this order. Moreover, between the intermediate layer 14 and the backing material 30, a flexible printed circuit board 20 is formed. Moreover, as shown in FIG. 2, a signal electrode 12 is interposed between the piezoelectric transducer 11 and the intermediate layer 14. An extraction signal electrode 15 formed by routing the signal electrode 12 on a side face of the intermediate layer 14 contiguous with one side face of the piezoelectric transducer 11 and extracting to the back face (a face on the side of a cable) of the intermediate layer 14, and a ground electrode 16 formed on the ultrasound transmission face of the piezoelectric transducer 11, routed on the other side face of the piezoelectric transducer 11 and on a side face of the intermediate layer 14 contiguous with the other side face of the piezoelectric transducer 11, and extracted to the back face (the face on the side of the cable) of the intermediate layer 14 are formed. In this description, a laminate composed of the piezoelectric transducer 11 and the intermediate layer 14 will be referred to as a piezoelectric oscillation component 10.

The flexible printed circuit board 20 includes a signal wiring pattern 22 and a ground wiring pattern 23. The extraction signal electrode 15 and the ground electrode 16 are electrically connected to the signal wiring pattern 22 and the ground wiring pattern 23, respectively, on the back face of the intermediate layer 14.

At an end of the signal electrode 12 opposite to an end electrically connected to the extraction signal electrode 15 between the piezoelectric transducer 11 and the intermediate layer 14, at an end opposite to an extraction direction of the ground electrode 16 on the ultrasound transmission face of the piezoelectric transducer 11, and at a place between the extraction signal electrode 15 and the ground electrode 16 sandwiched by the intermediate layer 14 and the flexible printed circuit board 20, electrode separations 13, 17 and 18 are formed, respectively, to separate the signal electrode 12 or the extraction signal electrode 15 from the ground electrode 16.

The configuration of each part will be specifically described hereinafter. In the following description, a direction of scanning with ultrasound will be a scan direction (a direction perpendicular to the sheet of FIG. 1), and a direction of focusing ultrasound will be a lens direction (a vertical direction on the sheet of FIG. 1). Moreover, in the lens direction, the upper side will be referred to as an ultrasound transmission face side, and the lower side will be referred to as a back face side.

Firstly, with reference to FIG. 2, a configuration of the piezoelectric oscillation component 10 will be specifically described.

FIG. 2 is a cross-section view of the piezoelectric oscillation component 10 formed by laminating the piezoelectric transducer 11 on the intermediate layer 14 and attaching a film-like electrode in this embodiment.

The piezoelectric transducer 11 is divided into a plurality of elements along the scan direction. The thickness of the piezoelectric transducer 11 is almost a quarter of the wavelength of ultrasound transmitted by the ultrasound probe according to this embodiment. As the material of the piezoelectric transducer 11, for example, piezoelectric ceramics such as zinc oxide (ZnO) and lead zirconate titanate (PZT) is used.

The intermediate layer 14 is formed on the back face (a face on the back face side) of the piezoelectric transducer 11, and the thickness thereof is almost a quarter of the wavelength of ultrasound transmitted by the ultrasound probe according to this embodiment. The intermediate layer 14 according to this embodiment is composed of a nonconductive material. As the material of the intermediate layer 14, that is, a material having acoustic impedance larger than that of the piezoelectric transducer 11 and being nonconductive, aluminum oxide, sapphire, silicon carbide (SiC) and so on are used.

The signal electrode 12 is interposed between the piezoelectric transducer 11 and the intermediate layer 14, and placed so as to cover almost the whole back face of the piezoelectric transducer 11. As the material of the signal electrode 12, favorably conductive metal such as gold, silver and copper is used.

The signal electrode 12 has a cutout at one end in a direction orthogonal to both the scan direction and lens direction, and this cutout configures the electrode separation 13 that insulates the signal electrode 12 from a ground-electrode side part 162 of the ground electrode 16 (the ground electrode 16 and the ground-electrode side part 162 will be described later). An insulator may be embedded into the electrode separation 13.

The electrode separation 13 needs enough width to insulate the ground-electrode side part 162 of the ground electrode 16 placed on the side faces of the piezoelectric transducer 11 and the intermediate layer 14 from the signal electrode 12. On the other hand, since voltage is not applied to a part of the piezoelectric transducer 11 on which the electrode separation 13 is placed, this part is an invalid part from which ultrasound is not oscillated. Therefore, it is desirable to set the width of the electrode separation 13 as narrow as possible. In a generally used ultrasound probe, it is desirable that the width of the electrode separation 13 is 0.3 mm or less.

The extraction signal electrode 15 includes: an extraction-signal-electrode side face 152 that extracts an end of the signal electrode 12 opposite to the electrode separation 13 to the adjacent side faces of the piezoelectric transducer 11 and the intermediate layer 14; and an extraction-signal-electrode connection part 153 that extracts the extraction-signal-electrode side face 152 to the back face of the intermediate layer 14. As the material of the extraction signal electrode 15, favorably conductive metal such as gold, silver and copper is used. The signal electrode 12 and the extraction signal electrode 15 are equivalent to a “first electrode.”

The extraction-signal-electrode side face 152 is electrically connected to the end of the signal electrode 12 opposite to the electrode separation 13, and placed so as to cover almost the whole side face of the intermediate layer 14 on at least the side connected to the signal electrode 12. The extraction-signal-electrode side face 152 may be configured to also cover the side face of the piezoelectric transducer 11 consecutive with the side face of the intermediate layer 14. In the following description, it is assumed that the side faces of both the intermediate layer 14 and the piezoelectric transducer 11 are covered by the extraction-signal-electrode side face 152.

The extraction-signal-electrode connection part 153 is placed so as to extract the extraction-signal-electrode side face 152 to the back face of the intermediate layer 14, and electrically connected to the signal wiring pattern 22 of the flexible printed circuit board 20 on the back face of the intermediate layer 14 (the flexible printed circuit board 20 and the signal wiring pattern 22 will be described later).

On the back face of the intermediate layer 14, a ground-electrode connection part 163 is placed. The ground-electrode connection part 163 is extracted from the side face of the intermediate layer 14 opposite to the face on which the extraction-signal-electrode connection part 153 is placed (the ground-electrode connection part 163 will be described later). At the center of the back face of the intermediate layer 14, an end of the ground-electrode connection part 163 faces an end of the extraction-signal-electrode connection part 153, and a cutout is formed at the end of the extraction-signal-electrode connection part 153. This cutout configures the electrode separation 18 that insulates the extraction-signal-electrode connection part 153 from the ground-electrode connection part 163. An insulator may be embedded into the electrode separation 18.

The electrode separation 18 needs enough width to insulate the extraction-signal-electrode connection part 153 from the ground-electrode connection part 163. On the other hand, in order to increase the quality of electrode connection between the extraction-signal-electrode connection part 153 and the signal wiring pattern 22 and between the ground-electrode connection part 163 and the ground wiring pattern 23 (that is, certainly connect), it is desirable to make the areas of the extraction-signal-electrode connection part 153 and the ground-electrode connection part 163 as large as possible (the flexible printed circuit board 20, the signal wiring pattern 22, and the ground wiring pattern 23 will be described later). Therefore, it is desirable to set the width of the electrode separation 18 as narrow as possible. In a generally used ultrasound probe, it is desirable that the width of the electrode separation 18 is 0.3 mm or less.

The ground electrode 16 includes: a ground electrode part 161 placed on the ultrasound transmission face of the piezoelectric transducer 11; the ground-electrode side part 162 that extracts the ground electrode part 161 to the side faces of the piezoelectric transducer 11 and intermediate layer 14 opposite to the faces on which the extraction-signal-electrode side face 152 is placed; and the ground-electrode connection part 163 that extracts the ground-electrode side part 162 to the back face of the intermediate layer 14. As the material of the ground electrode 16, favorably conductive metal such as gold, silver and copper is used. The ground electrode 16 is equivalent to a “second electrode.”

The ground electrode part 161 is placed so as to cover almost the whole ultrasound transmission face of the piezoelectric transducer 11. Since voltage is applied between the ground electrode part 161 and the signal electrode 12, a part covered by the ground electrode part 161 is an execution driving part. Therefore, it is desirable to make the ground electrode part 161 as large as possible.

The ground-electrode side part 162 is placed so as to cover the almost whole side faces of the piezoelectric transducer 11 and the intermediate layer 14 opposite to the faces on which the extraction-signal-electrode side face 152 is placed. The ground electrode part 161 and the ground-electrode side part 162 are electrically connected, and the ground electrode part 161 is extracted by the ground-electrode side part 162 to the side faces of the piezoelectric transducer 11 and intermediate layer 14.

The ground-electrode connection part 163 is placed so as to extract the ground-electrode side part 162 to the back face of the intermediate layer 14, and is electrically connected to the ground wiring pattern 23 of the flexible printed circuit board 20 on the back face of the intermediate layer 14 (the flexible printed circuit board 20 and the ground wiring pattern 23 will be described later).

At an end of the ground electrode part 161 opposite to the side connected to the ground-electrode side part 162, a cutout is formed.

This cutout configures the electrode separation 17 that insulates the extraction-signal-electrode side face 152 from the ground-electrode side part 162. An insulator may be embedded into the electrode separation 17.

The electrode separation 17 needs enough width to insulate the extraction-signal-electrode side face 152 from the ground-electrode side part 162. On the other hand, since voltage is not applied to a part of the piezoelectric transducer 11 on which the electrode separation 17 is placed, this part is an invalid part from which ultrasound is not oscillated. Therefore, it is desirable to set the width of the electrode separation 17 as narrow as possible. In a generally used ultrasound probe, it is desirable that the width of the electrode separation 17 is 0.3 mm or less.

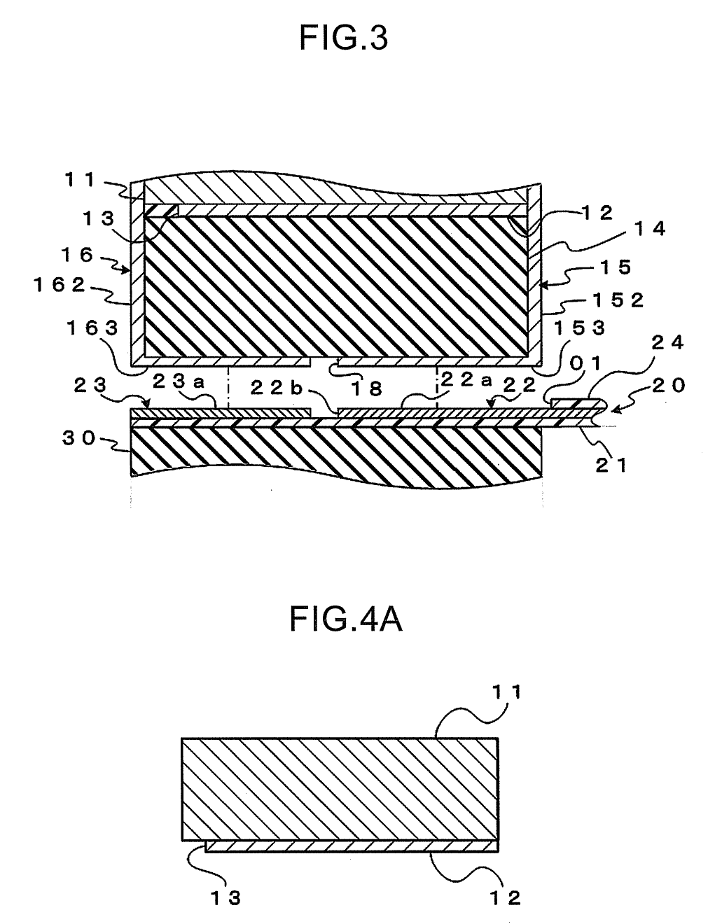

Next, a configuration of the flexible printed circuit board 20 will be described with reference to FIG. 3. FIG. 3 is an exploded view of the piezoelectric oscillation component 10, the backing material 30 and the flexible printed circuit board 20 in this embodiment.

The flexible printed circuit board 20 transmits a driving signal for the piezoelectric transducer 11 and a reception signal coming from the piezoelectric transducer 11, and is interposed between the piezoelectric oscillation component 10 and the backing material 30.

The flexible printed circuit board 20 is composed of a first insulation layer 21, the signal wiring pattern 22, the ground wiring pattern 23 and a second insulation layer 24, which are laminated in this order along a direction from the backing material 30 to the piezoelectric oscillation component 10.

The second insulation layer 24 has an eliminated region slightly larger than a part corresponding to the back face of the piezoelectric oscillation component 10 within the plane orthogonal to the lens direction. That is to say, the second insulation layer 24 has an opening 01 formed slightly larger than the back face of the piezoelectric oscillation component 10 within the plane orthogonal to the lens direction. Thus, the signal wiring pattern 22 and the ground wiring pattern 23 are exposed to the extraction-signal-electrode connection part 153 and the ground-electrode connection part 163 formed on the back face of the piezoelectric oscillation component 10.

The signal wiring pattern 22 is equivalent to a “first wiring pattern,” and the ground wiring pattern 23 is equivalent to a “second wiring pattern.”

The extraction-signal-electrode connection part 153 is electrically connected to an exposed face 22a of the signal wiring pattern 22. Moreover, the ground electrode connection pattern 163 is electrically connected to an exposed face 23a of the ground wiring pattern 23.

The backing material 30 absorbs ultrasound propagating toward the back face of the piezoelectric transducer 11, and is placed on the back face side of the piezoelectric oscillation component 10 (on the back face side of the intermediate layer 14). As the material of the backing material 30, which is not particularly limited, rubber or the like having favorable sound absorbability is used.

For joining the backing material 30 and the flexible printed circuit board 20, and joining the flexible printed circuit board 20 and the piezoelectric oscillation component 10, a method as used in a conventional technique can be used. As a general method for joining the backing material 30 and the flexible printed circuit board 20, joining by an adhesive is well known. Moreover, as a general method for joining the flexible printed circuit board 20 and the piezoelectric oscillation component 10, joining by solder and joining by an adhesive are well known.

An acoustic lens 50 (refer to FIG. 1) focuses transmitted/received ultrasound to form into a beam, and is placed on the ultrasound transmission side of the acoustic matching layer 40 (the acoustic matching layer 40 will be described later). As the material of the acoustic lens 50, for example, silicone having acoustic impedance close to that of a living body is used.

The acoustic matching layer 40 performs acoustic matching of the piezoelectric transducer 11 and the acoustic lens 50, and is interposed between the piezoelectric transducer 11 and the acoustic lens 50. The acoustic matching layer 40 includes a first acoustic matching layer 41 and a second acoustic matching layer 42. The materials of the first and second acoustic matching layers 41 and 42, which are not particularly limited, are selected so that acoustic impedance gradually changes along a direction from the piezoelectric transducer 11 to the acoustic lens 50.

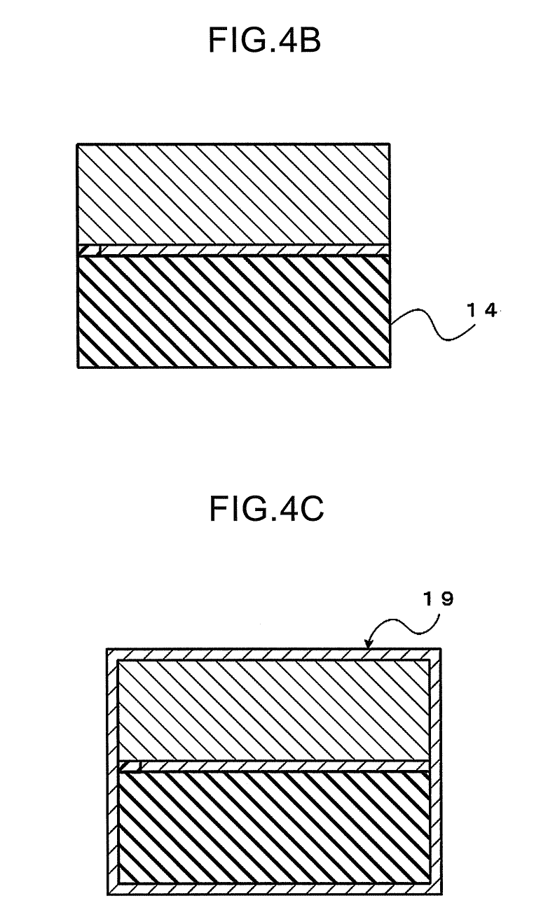

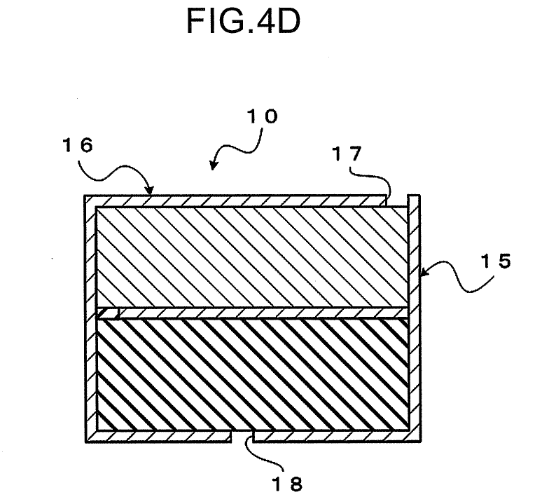

Next, a method for generating the piezoelectric oscillation component 10 will be described with reference to FIGS. 4A-4D. FIGS. 4A-4D are views for explaining the method for generating the piezoelectric oscillation component 10 in the embodiment, and show the respective steps in generation of the piezoelectric oscillation component 10 in order of FIGS. 4A-4D.

<a1> First, as shown in FIG. 4A, on the back face of the piezoelectric transducer 11 processed to a thickness of almost a quarter of the wavelength of ultrasound, the signal electrode 12 is generated by plating or sputtering. At this moment, it is desirable to mold the respective members so as to have external dimensions slightly larger than desired dimensions, in order to precisely process the external shapes in the latter steps. Moreover, at one end of the signal electrode 12 in a direction orthogonal to both the scan direction and the lens direction, the electrode separation 13 is formed by masking or dicing.

<a2> Next, as shown in FIG. 4B, the intermediate layer 14 processed to a thickness of substantially a quarter of the wavelength of ultrasound is joined to the back face of the piezoelectric transducer 11 so as to sandwich the signal electrode 12. At this moment, an insulator may be embedded into the electrode separation 13. To join the intermediate layer 14, it is general to employ adhesion joining with an epoxy adhesive or the like. After the intermediate layer 14 is joined, a laminate of the piezoelectric transducer 11 and the intermediate layer 14 is processed and molded to a desired dimension. In this case, it is desirable that the width of the electrode separation 13 is about 0.3 mm or less.

<a3> Next, as shown in FIG. 4C, on the laminate of the piezoelectric transducer 11 and the intermediate layer 14, an electrode film 19 is formed by plating or sputtering. As the material of the electrode film 19, favorably conductive metal such as gold, silver and copper is used.

<a4> Finally, as shown in FIG. 4D, the electrode separation 17 and the electrode separation 18 are formed by dicing to separate the electrode film 19 into the extraction signal electrode 15 and the ground electrode 16. At this moment, the electrode separation 17 is formed, on the ultrasound transmission face of the piezoelectric transducer 11, at an end opposite to the electrode separation 13 with respect to a direction orthogonal to both the scan direction and the lens direction.

Moreover, the electrode separation 18 is formed at the center in the direction orthogonal to both the scan direction and the lens direction on the back face of the intermediate layer 14. In this case, it is desirable to mold so that the widths of the electrode separations 17 and 18 are 0.3 mm or less.

Thus, the piezoelectric oscillation component 10 is generated.

The method for generating the electrode separations 17 and 18 is not limited to dicing. The electrode film 19 may be generated after a masking process is executed on the positions to form the electrode separations 17 and 18 in step <a3>.

Thus, it is possible, even in the structure with the intermediate layer 14 formed on the back face of the piezoelectric transducer 11, to extract a signal electrode (the signal electrode 12) and a ground electrode (the ground electrode part 161) placed on the piezoelectric transducer 11 to wiring patterns (the signal wiring pattern 22 and the ground wiring pattern 23) of the flexible printed circuit board 20 located on the back face of the intermediate layer 14. Consequently, the need for forming a flexible printed circuit board on the ultrasound transmission face of the piezoelectric transducer 11 is eliminated, and therefore, it is possible to prevent deterioration of the acoustic property.

Further, since the area of the invalid part of the piezoelectric transducer 11 is smaller than in a conventional type and the ultrasound probe can be downsized, it is possible to increase the operability of the ultrasound probe.

Furthermore, it becomes possible to, while maintaining the area of an effective part of the piezoelectric transducer 11, connect a signal electrode (the extraction-signal-electrode connection part 153) and a ground electrode (the ground-electrode connection part 163) to the signal wiring pattern 22 and the ground wiring pattern 23 of the flexible printed circuit board 20, respectively, on the back face of the intermediate layer 14. Thus, it is possible to join both the signal electrode and the ground electrode with larger areas than in a conventional type, and it becomes possible to increase the quality of electrode connection.

### Modified Example 1

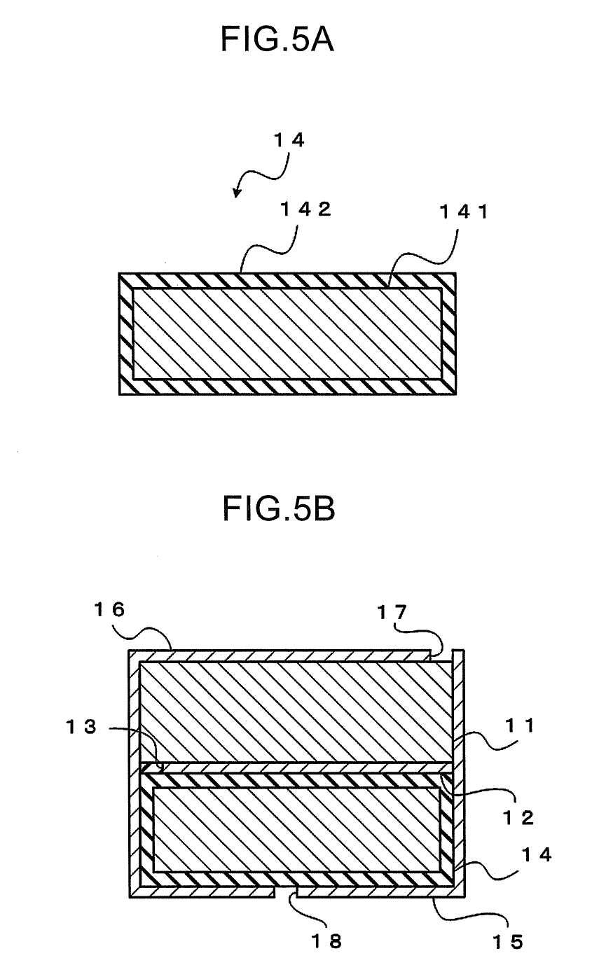

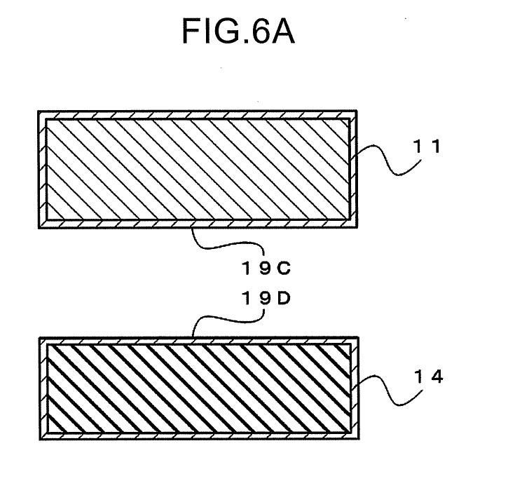

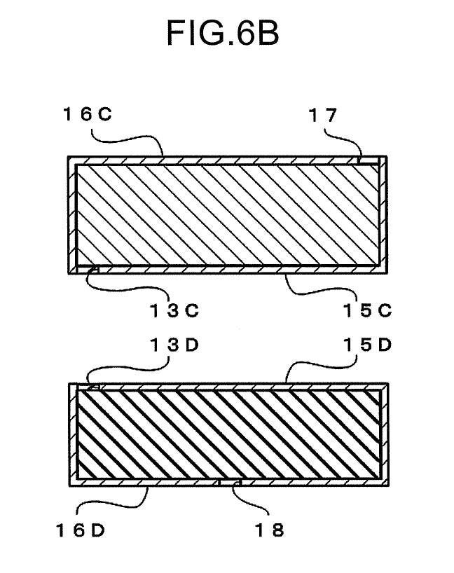

Next, an ultrasound probe according to a modified example 1 will be described. FIGS. 5A and 5B are views for describing a method for generating the piezoelectric oscillation component 10 in the modified example 1.

The ultrasound probe according to the modified example 1 has the piezoelectric oscillation component 10 in which the intermediate layer 14 is composed of a conductive material. The other configurations are similar to those of the embodiment. A configuration and generation method of the intermediate layer 14 different from those of the embodiment will be described herein.

FIG. 5A shows the configuration of the intermediate layer 14 of the modified example 1. As shown in FIG. 5A, the intermediate layer 14 of the modified example 1 is configured so that an intermediate layer base 141 having conductivity is covered with an insulation film 142.

As the material of the intermediate layer base 141, namely, a material having larger acoustic impedance than the piezoelectric transducer 11 and having conductivity, gold, lead, tungsten or the like is used. By executing an insulation process on the intermediate layer base 141, the insulation film 142 is formed.

As a method of the insulation process, a method of executing oxidation or nitridation treatment on the whole circumference of the intermediate layer base 141 to modify only the surface and form the insulation film 142 is known. Moreover, as a method different from the abovementioned insulation process, the insulation film 142 may be formed by executing a process of covering the whole circumference of the intermediate layer base 141 with the insulation layer (for example, a deposited film of aluminum oxide).

Thus, by executing an insulation process on the conductive intermediate layer base 141 and forming the insulation film 142, it is possible to configure the intermediate layer 14 so as to have an insulation function.

FIG. 5B is a cross-section view of the piezoelectric oscillation component 10 in the modified example 1. The intermediate layer 14 of the modified example 1 and the intermediate layer 14 of the abovementioned embodiment are different in material to compose, but have the same property. Therefore, as shown in FIG. 5B, it is possible to configure the piezoelectric oscillation component 10 by using the intermediate layer 14 of the modified example 1, and it is possible to generate the piezoelectric oscillation component 10 in a like manner as in the abovementioned embodiment.

Thus, with a conductive material for the intermediate layer, it is possible to realize the piezoelectric oscillation component 10 equal to the abovementioned embodiment.

### Modified Example 2

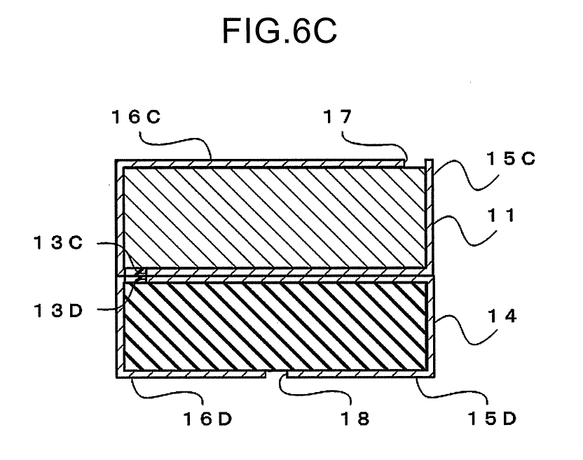

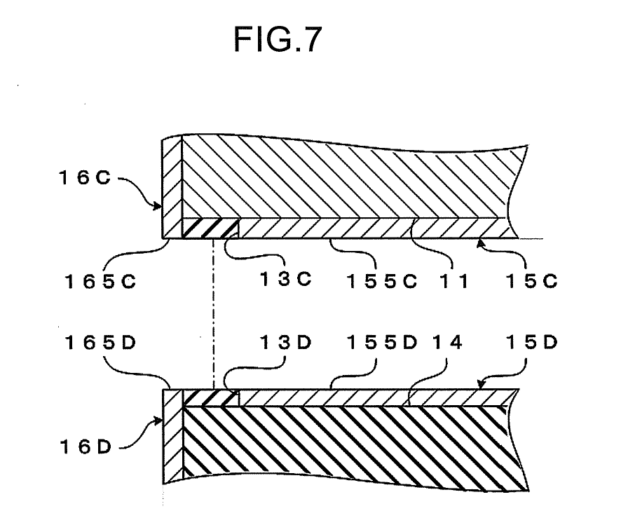

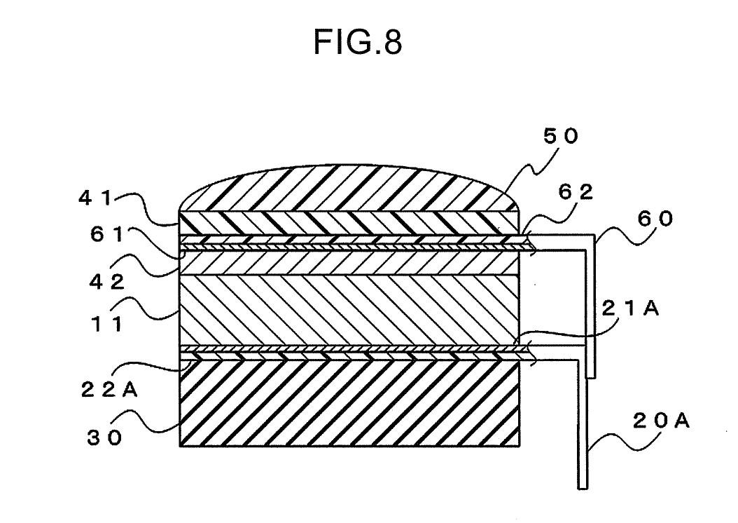

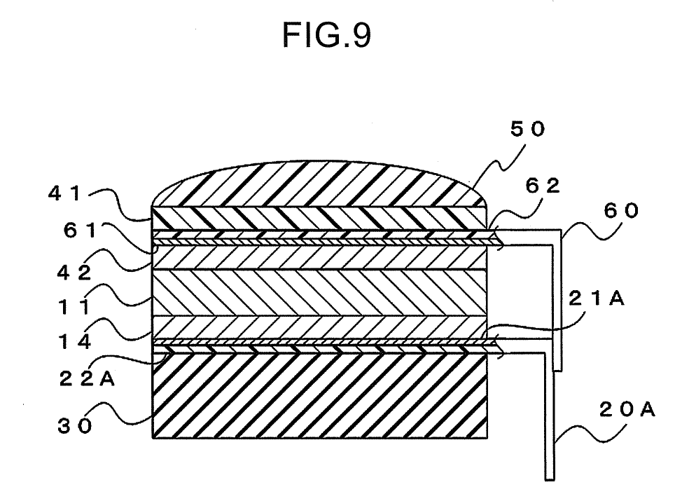

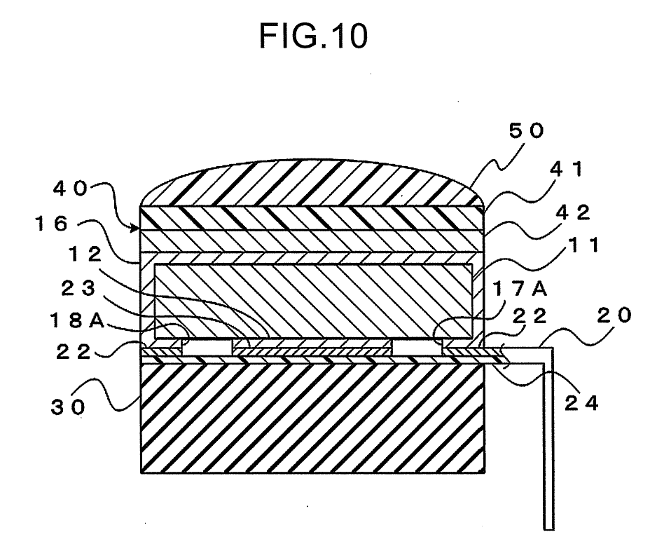

Next, with reference to FIGS. 6A-6C and FIG. 7, a method for more easily generating the piezoelectric oscillation component 10 according to the abovementioned embodiment will be described as a modified example 2. FIGS. 6A-6C are views describing the method for generating the piezoelectric oscillation component 10 in the modified example 2, and show the respective steps in generation of the piezoelectric oscillation component 10 in order of FIGS. 6A-6C.

Moreover, FIG. 7 is a magnified cross-section view of FIG. 6B.

<b1> First, as shown in FIG. 6A, a piezoelectric-transducer-side electrode film 19C is generated by plating or sputtering on the piezoelectric transducer 11 processed to a thickness of almost a quarter of the wavelength of ultrasound. Moreover, an intermediate-layer-side electrode film 19D is generated by plating or sputtering on the intermediate layer 14 processed to a thickness of almost a quarter of the wavelength of ultrasound. As the material of the piezoelectric-transducer-side electrode film 19C and the intermediate-layer-side electrode film 19D, favorably conductive metal such as gold, silver and copper is used similarly to the electrode film 19 of the abovementioned embodiment.

<b2> Next, as shown in FIG. 6B, on the ultrasound transmission face of the piezoelectric transducer 11, the electrode separation 17 is formed by cutting one end in a direction orthogonal to both the scan direction and the lens direction of the piezoelectric-transducer-side electrode film 19C. Moreover, on the back face of the piezoelectric transducer 11, a piezoelectric-transducer-side electrode separation 13C is formed by cutting an end on the opposite side to the electrode separation 17. Consequently, the piezoelectric-transducer-side electrode film 19C is separated into a piezoelectric-transducer-side signal electrode 15C and a piezoelectric-transducer-side ground electrode 16C.

In a like manner, the electrode separation 18 is formed by cutting the center on the back face of the intermediate layer 14.

Moreover, as shown in FIG. 7, on a face of the intermediate layer 14 facing the back face of the piezoelectric transducer 11, an intermediate-layer-side electrode separation 13D is formed by cutting a position facing the piezoelectric-transducer-side electrode separation 13C. Consequently, the intermediate-layer-side electrode film 19D is separated into an intermediate-layer-side signal electrode 15D and an intermediate-layer-side ground electrode 16D.

The electrode separation 17, the electrode separation 18, the piezoelectric-transducer-side electrode separation 13C and the intermediate-layer-side electrode separation 13D may be formed by cutting the piezoelectric-transducer-side electrode film 19C and the intermediate-layer-side electrode film 19D by dicing or etching, or may be formed by masking when forming the piezoelectric-transducer-side electrode film 19C and the intermediate-layer-side electrode film 19D.

Further, into the piezoelectric-transducer-side electrode separation 13C, the intermediate-layer-side electrode separation 13D, the electrode separation 17 and the electrode separation 18, an insulator may be embedded.

<b3> Next, as shown in FIG. 6C, the back face of the piezoelectric transducer 11 and the face of the intermediate layer 14 facing the back face of the piezoelectric transducer are joined. At this moment, as shown in FIG. 7, an end 165C of the piezoelectric-transducer-side ground electrode 16C and an end 165D of the intermediate-layer-side ground electrode 16D are electrically connected, and a joint face 155C of the piezoelectric-transducer-side signal electrode 15C located on the back face of the piezoelectric transducer 11 and a joint face 155D of the intermediate-layer-side signal electrode 15D facing the joint face 155C are electrically connected. Moreover, the piezoelectric-transducer-side electrode separation 13C and the intermediate-layer-side electrode separation 13D are joined, and the ends 165C and 165D are insulated from the joint faces 155C and 155D. As a method for joining the piezoelectric transducer 11 and the intermediate layer 14, metal fusion or adhesion by a conductive adhesive may be generally used.

Thus, it becomes possible to more easily generate the piezoelectric oscillation component 10 by a different method from the generation method described in the abovementioned embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ultrasound probe in which a piezoelectric transducer, an intermediate member and a backing material are superposed in this order on a face on an opposite side to an ultrasound transmission face of the piezoelectric transducer, the ultrasound probe comprising:
a flexible printed circuit board interposed between the intermediate member and the backing material, configured to cover an almost whole back face of the intermediate layer, and provided with a first wiring pattern and a second wiring pattern;
a first electrode interposed between the piezoelectric transducer and the intermediate member, extracted by being routed on a side face of the intermediate member contiguous with one side face of the piezoelectric transducer, and electrically connected to the first wiring pattern; and
a second electrode formed on the ultrasound transmission face of the piezoelectric transducer, extracted by being routed on the other side face of the piezoelectric transducer and a side face of the intermediate member contiguous with the other side face of the piezoelectric transducer, and electrically connected to the second wiring pattern.

2. The ultrasound probe according to claim 1, wherein one or both of the first wiring pattern and the second wiring pattern are further extracted to between the intermediate member and the flexible printed circuit board.

3. The ultrasound probe according to claim 1, wherein electrode separations are formed, one of which is formed between the piezoelectric transducer and the intermediate member at an end of the first electrode opposite to a direction in which the first electrode is extracted, and the other of which is formed on the ultrasound transmission face of the piezoelectric transducer at an end of the second electrode on an opposite side to a direction in which the second electrode is extracted.

4. The ultrasound probe according to claim 1, wherein acoustic impedance of the intermediate member is higher than acoustic impedances of the piezoelectric transducer and the backing member, a thickness of the piezoelectric transducer is almost a quarter of a wavelength of ultrasound to be transmitted, and a thickness of the intermediate member is almost a quarter of the wavelength of the ultrasound.

5. The ultrasound probe according to claim 1, wherein the intermediate member is nonconductive.

6. The ultrasound probe according to claim 1, wherein the intermediate member is conductive, and the intermediate member is insulated from periphery.
